(19) United States
(12) Patent Application Publication
(10) Pub. No.: US 2026/0246121 A1
(43) Pub. Date: Aug. 20, 2026

(54) SECONDARY BATTERY AND BATTERY PACK INCLUDING THE SECONDARY BATTERY

(71) Applicant: SAMSUNG SDI CO., LTD., Yongin-si (KR)

(72) Inventor: Jae Il SEONG, Yongin-si (KR)

(21) Appl. No.: 19/242,488

(22) Filed: Jun. 18, 2025

(30) Foreign Application Priority Data
Feb. 20, 2025 (KR) 10-2025-0022329

(51) Int. Cl. H01M 50/593; H01M 50/586; H01M 50/609

(52) U.S. Cl. CPC H01M 50/593; H01M 50/586; H01M 50/609

(57) ABSTRACT

A secondary battery includes a case having an opening formed therein, the case extending in a first direction, an electrode assembly accommodated in the case and a cap assembly sealing the opening in the case. The battery also includes an insulating member including an insulating member body disposed between the electrode assembly and the cap assembly, the insulating member including an inclined surface disposed on an upper side of the insulating member body and extending in a direction intersecting a second direction perpendicular to the first direction. An insulating member hole is formed in the insulating member body, with the insulating member hole extending through the insulating member body.

### CROSS-REFERENCE TO RELATED APPLICATION

The present application claims priority and the benefit of Korean Patent Application No. 10-2025-0022329, filed on February 20, 2025, in the Korean Intellectual Property Office, the entire disclosure of which is incorporated herein by reference.

### BACKGROUND

### 1. Field of the Invention

The present disclosure relates to a secondary battery and a battery pack including the secondary battery.

### 2. Discussion of Related Art

With the rapid spread of electronic devices using batteries such as mobile phones, notebook computers, and electric vehicles, the demand for secondary batteries having high energy density and high capacity is has increased. Accordingly, the research and development for improving the performance of lithium secondary batteries is being conducted.

A lithium secondary battery includes an electrolyte and positive and negative electrodes containing an active material capable of the intercalation and deintercalation of lithium ions. The secondary battery produces electric energy by oxidation and reduction reactions when the lithium ions are intercalated into and deintercalated from the positive electrode and the negative electrode.

The above information disclosed in this section is provided for enhancement of understanding of the background of the present disclosure. It may contain information that does not constitute related or prior art.

### SUMMARY OF THE DISCLOSURE

The present disclosure is directed to providing a secondary battery that minimizes the time required for electrolyte injection and a battery pack including the secondary battery.

In addition, the present disclosure is also directed to providing a secondary battery with improved stability and a battery pack including the secondary battery.

These and other aspects and features of the present disclosure will be described in or will be apparent from the following description of some embodiments of the present disclosure.

According to the present disclosure, there is provided a secondary battery including a case having an opening formed therein, the case extending in a first direction, an electrode assembly accommodated in the case, a cap assembly sealing the opening, and an insulating member including an insulating member body disposed between the electrode assembly and the cap assembly, the insulating member including an inclined surface disposed on an upper side of the insulating member body and extending in a direction intersecting a second direction perpendicular to the first direction, and an insulating member hole is formed in the insulating member body, with the insulating member hole extending through the insulating member body.

A length of the insulating member in the first direction may decrease toward a center of the insulating member to thereby form an inclination of the inclined surface.

The insulating member hole may be disposed in a central portion of the insulating member body in the second direction.

The insulating member may include a second insulating member hole disposed at an edge of the insulating member body and extending through the insulating member body.

A sum of a cross-sectional area of the first insulating member hole and a cross-sectional area of the second insulating member hole may range from 10% to 50% of a cross-sectional area of the insulating member.

The insulating member may include an insulating member groove formed as a concave groove in the inclined surface.

The insulating member groove may be connected to the insulating member hole.

The insulating member may include hole is a first insulating member hole, and a second insulating member hole is formed at an edge of the insulating member body and extends through the insulating member body, and an insulating member groove formed as a concave groove in the inclined surface and connected to the second insulating member hole.

A cross-sectional shape of the insulating member groove may be triangular, and a depth of the insulating member groove may be 5% to 40% of a length of the insulating member in the first direction.

The electrode assembly may include an electrode tab electrically connected to the cap assembly and extending through the insulating member.

The insulating member body may include a plurality of insulating member body pieces that overlap each other.

The plurality of insulating member body pieces may be rotatable about the insulating member hole.

The insulating member may include an insulating body disposed on the inclined surface.

The insulating member may include an adhesive disposed between the inclined surface and the insulating body to fix the insulating body to the inclined surface.

Lengths of the insulating body and the adhesive in the first direction may be 70% or less of a maximum length of the insulating member in the first direction.

An area of the insulating body may be 50% or less of an area of the inclined surface.

According to the present disclosure, there is provided a battery pack including a housing and a plurality of secondary batteries disposed in the housing, wherein the secondary battery includes a case having an opening formed therein, the case extending in a first direction, an electrode assembly accommodated in the case, a cap assembly sealing the opening in the case, and an insulating member including an insulating member body disposed between the electrode assembly and the cap assembly, the insulating member including an inclined surface disposed on an upper side of the insulating member body and extending in a direction intersecting a second direction perpendicular to the first direction, and an insulating member hole is formed in the insulating body, with the insulating member hole extending through the insulating member body.

A length of the insulating member in the first direction may decrease toward a center of the insulating member.

The first insulating member hole may be disposed in a central portion of the insulating member body in the second direction.

The insulating member may include a second insulating member hole disposed at an edge of the insulating member body and extend through the insulating member body.

The insulating member may include an insulating member groove formed as a concave groove in the inclined surface.

The insulating member groove may be connected to the first insulating member hole.

### BRIEF DESCRIPTION OF THE DRAWINGS

The drawings attached to this specification illustrate embodiments of the present disclosure and further describe aspects and features of the present disclosure together with the detailed description of the present disclosure. But the present disclosure is not limited to embodiments depicted in the drawings.

FIG. 1 is a schematic perspective view of a configuration of a battery pack according to various embodiments of the present disclosure;

FIG. 2 is a schematic perspective view of a configuration of a secondary battery according to an embodiment of the present disclosure;

FIG. 3 is a schematic exploded perspective view of the configuration of the secondary battery according to one embodiment of the present disclosure;

FIG. 4 is a schematic exploded perspective view of a configuration of a cap assembly according to one embodiment of the present disclosure;

FIG. 5 is a schematic cross-sectional view of the configuration of the secondary battery according to an embodiment of the present disclosure;

FIG. 6 is a perspective view of an insulating member according to a first embodiment of the present disclosure;

FIG. 7 is a cross-sectional view of the insulating member according to the first embodiment of the present disclosure;

FIG. 8 is a perspective view of an insulating member according to a second embodiment of the present disclosure;

FIG. 9 is a cross-sectional view of an insulating member according to a third embodiment of the present disclosure;

FIG. 10 is a cross-sectional view of an insulating member according to a fourth embodiment of the present disclosure;

FIG. 11 is a cross-sectional view of an insulating member according to a fifth embodiment of the present disclosure;

FIG. 12 is a plan view of an insulating member according to a sixth embodiment of the present disclosure;

FIG. 13 is a plan view of an insulating member according to a seventh embodiment of the present disclosure; and

FIGS. 14 to 16 are plan views of an insulating member according to an eighth embodiment of the present disclosure.

### DETAILED DESCRIPTION OF EXEMPLARY EMBODIMENTS

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein includes all sub-ranges of the same numerical precision subsumed within the recited range. For example, a range of "1.0 to 10.0" includes all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification includes all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the "above (or below)" or "on (or under)" a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or "connected" to another element, the elements may be directly “coupled,” “linked,” or "connected" to each other, or one or more intervening elements may be present therebetween, through which the element may be “coupled,” “linked,” or “connected” to another element. In addition, when a part is referred to as being "electrically coupled" to another part, the part may be directly electrically connected to another part or one or more intervening parts may be present therebetween such that the part and the another part are indirectly electrically connected to each other.

Throughout the specification, when "A and/or B" is stated, it means A, B, or A and B, unless otherwise stated. That is, “and/or” includes any or all combinations of a plurality of items enumerated. When "C to D" is stated, it means C or more and D or less, unless otherwise specified.

Hereinafter, a secondary battery and a battery pack including the same according to various embodiments of the present disclosure will be described with reference to the accompanying drawings. In this description, thicknesses of lines, sizes of components, etc., illustrated in the drawings may be exaggerated for clarity and convenience of the description. In addition, terms to be described below are the terms defined in consideration of functions in the present disclosure, which may be changed according to a user or operator’s intention or custom. Accordingly, the definition of these terms should be made based on the contents throughout the specification.

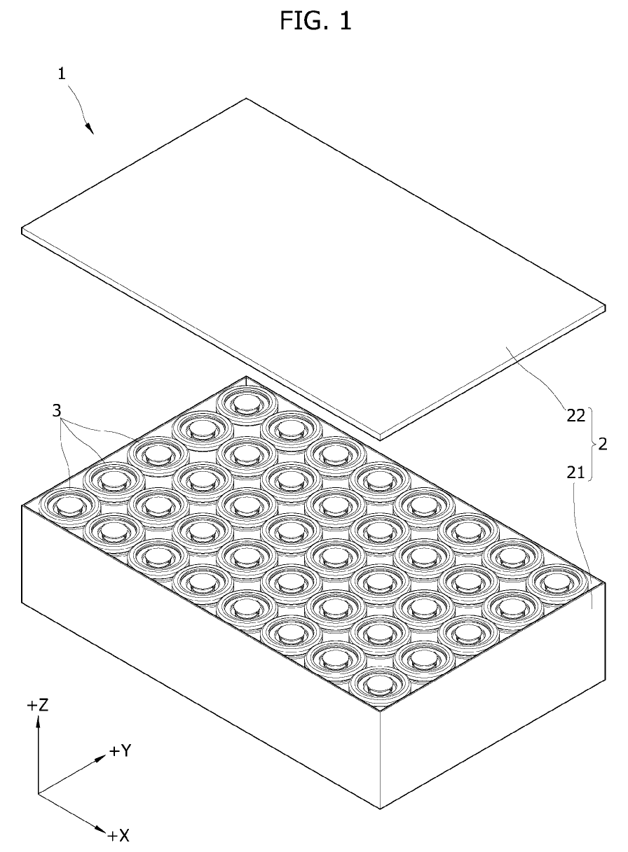

FIG. 1 is a schematic perspective view of a configuration of a battery pack according to various embodiments of the present disclosure.

Referring to FIG. 1, a battery pack 1 according to various embodiments may include a housing 2, a secondary battery 3, and a bus bar.

The housing 2 may form the exterior of the battery pack 1 and provide a space in which the secondary battery 3 may be accommodated.

The housing 2 according to the present embodiment may include a housing body 21 and a cover 22.

The housing body 21 may be in a box shape with an empty interior and be open on one side. A cross-sectional shape of the housing body 21 is not limited to a quadrangular shape as illustrated in FIG. 1 and may be other various shapes, such as a polygon, circle, oval, etc.

The cover 22 may be coupled to the housing body 21 and may close an internal space of the housing body 21. For example, the cover 22 may be formed to have a substantially plate shape and disposed to face the open side of the housing body 21. The cover 22 may be fixed to the housing body 21 by various types of coupling structures, such as bolting, welding, fitting, etc.

The secondary battery 3 may function as a unit structure that stores and supplies power in and to the battery pack.

The secondary battery 3 may be provided as a plurality of secondary batteries. The secondary batteries 3 may be disposed in various patterns, such as a grid shape, a zigzag shape, etc., inside the housing 2. The secondary batteries 3 may be disposed in parallel. Various numbers of secondary batteries 3 may be provided based on the size, shape, etc. of the housing 2. The detailed configuration of the secondary battery will be described below.

The bus bar may electrically connect the secondary batteries 3, which may be connected in series or in parallel by the bus bar. For example, the bus bar may connect the secondary batteries 3 disposed along the same row inside the housing 2 in parallel and connect the secondary batteries 3 disposed along two adjacent rows in series. The bus bar may be formed of an electrically conductive material, such as copper, aluminum, nickel, etc.

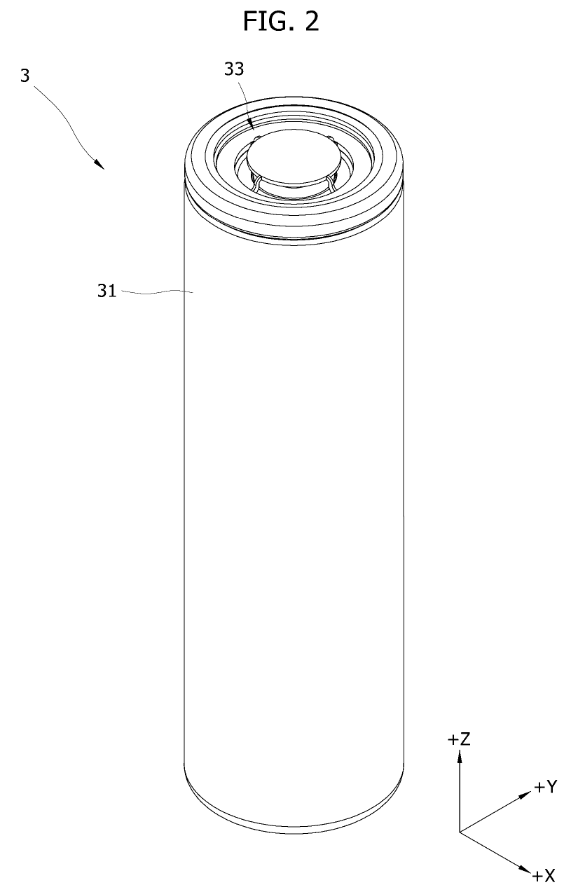

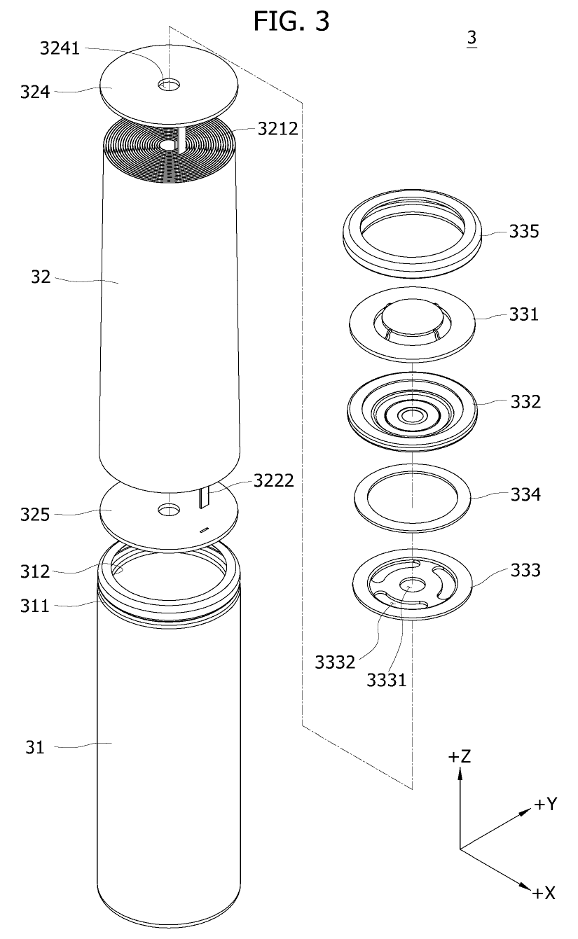

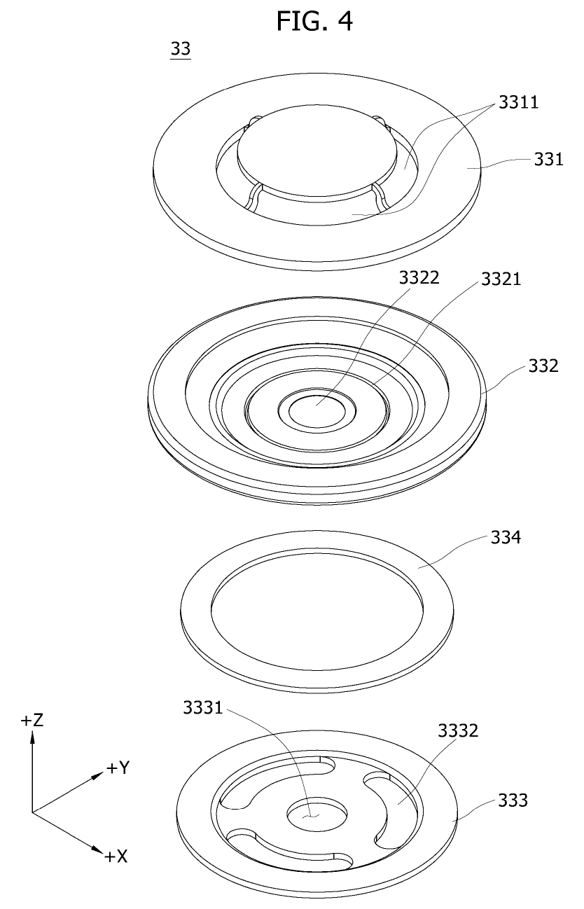

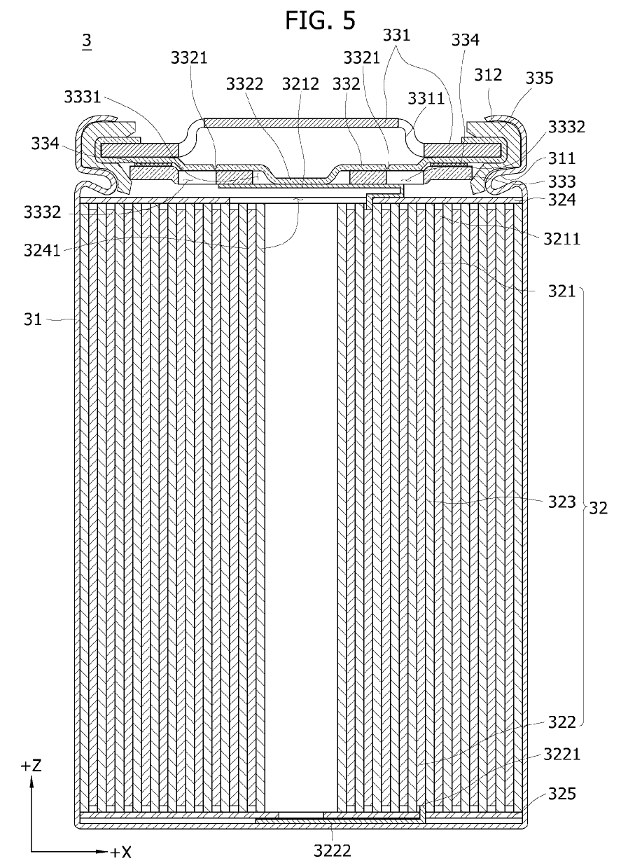

FIG. 2 is a schematic perspective view of a configuration of a secondary battery according to an embodiment of the present disclosure, FIG. 3 is a schematic exploded perspective view of the configuration of the secondary battery according to an embodiment of the present disclosure, FIG. 4 is a schematic exploded perspective view of a configuration of a cap assembly according to an embodiment of the present disclosure, and FIG. 5 is a schematic cross-sectional view of the configuration of the secondary battery according to an embodiment of the present disclosure.

The secondary battery 3 illustrated in FIGS. 2 to 5 may be the same as the secondary batteries 3 in the battery pack 1 illustrated in FIG. 1.

Referring to FIGS. 2 to 5, the secondary battery 3 according to the present embodiment may include a case 31, an electrode assembly 32, and a cap assembly 33.

Hereinafter, an example in which the secondary battery 3 is a cylindrical lithium ion secondary battery will be described. However, the present disclosure is not limited thereto, and the secondary battery 3 may be, for example, a lithium polymer battery or a prismatic battery.

The case 31 constituting the original form of the secondary battery 3 may be provided in various shapes. According to an embodiment, the case 31 may be provided in a circular shape. But the shape of the case 31 is not limited to a circular shape, and the case may be provided, for example, in a prismatic shape including a polygonal bottom surface.

The case 31 includes an opening at one side thereof, and the electrode assembly 32 may be accommodated in the case 31 after inserted through the opening. The case 31 may be formed of a conductive material, such as iron, an iron alloy, plated iron, steel, a steel alloy, plated steel, stainless steel, a stainless steel alloy, aluminum, or an aluminum alloy. Such materials may protect the electrode assembly 32 from an external impact and serve as a heat radiation plate through which heat generated by the charge/discharge operation of the electrode assembly 32 is discharged to the outside. In addition, since a bottom surface of the case 31 is electrically connected to a second electrode tab 3222 by welding, etc., the case 31 may serve as a second electrode.

The case 31 may extend in a first direction (e.g., in a Z-axis direction). The electrode assembly 32 may be disposed inside the case 31. In particular, the electrode assembly 32 may be disposed to be accommodated inside the case 31.

The electrode assembly 32 may function as a unit structure that performs the charging and discharging operation of power in a secondary battery. The electrode assembly 32 may include a first electrode plate 321, a second electrode plate 322, and a separator 323 disposed between the first electrode plate 321 and the second electrode plate 322.

The electrode assembly 32 may be a wound type centered on a winding axis. More specifically, the electrode assembly 32 may be a wound type in which the first electrode plate 321, the separator 323, and the second electrode plate 322 are stacked and wound about the winding axis clockwise or counterclockwise. Accordingly, the electrode assembly 32 may have a substantially jelly roll shape. A cross-sectional shape of the electrode assembly 32 may be various shapes, such as an oval, polygonal shape, etc., in alternative to a circular shape. Here, the winding axis may be along a straight line that passes through a central portion of the electrode assembly 32.

The first electrode plate 321 may function as a positive electrode of the electrode assembly 32. The first electrode plate 321 may be a foil including a metallic material, such as aluminum or an aluminum alloy. The type, size, shape, etc., of the first electrode 321 are not limited as long as the first electrode 321 has conductivity and does not cause a chemical change in a secondary battery.

At least a part of the first electrode plate 321 may be coated with a first active material layer. Both surfaces of the first electrode plate 321 may be coated with the first active material layer. In another embodiment, only one surface of the first electrode plate 321 may be coated with the first active material layer.

Since the first electrode plate 321 functions as a positive electrode, the first active material layer may include a positive electrode active material.

The positive electrode active material may be a compound capable of reversible intercalation and deintercalation of lithium (a lithiated intercalation compound). More specifically, as the positive electrode active material, one or more of composite oxides of a metal selected from cobalt, manganese, nickel, iron, and a combination thereof and lithium may be used. For example, the positive electrode active material may include at least one of lithium-cobalt oxide (LiCoO₂, LCO), lithium-nickel-cobalt-aluminum oxide (LiNiₓCo_{y}Al_{z}O₂, NCA), lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). The positive electrode active material may include only one of lithium-cobalt oxide (LiCoO₂, LCO), lithium-nickel-cobalt-aluminum oxide (LiNiₓCo_{y}Al_{z}O₂, NCA), lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM) or include two or all of lithium-cobalt oxide (LiCoO₂, LCO), lithium-nickel-cobalt-aluminum oxide (LiNiₓCo_{y}Al_{z}O₂, NCA), lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM). In these chemical formulas, 0<x<1, 0<y<1, 0<z<1, and x+y+z=1 may be satisfied.

The first active material layer may further include a positive electrode conductive material. The positive electrode conductive material is used to provide conductivity in the first active material layer, and any material that is an electrically conductive material without causing a chemical change may be used. Examples the positive electrode conductive material include carbon-based materials, such as natural graphite, artificial graphite, carbon black, acetylene black, Ketjen black, carbon fibers, carbon nanofibers, carbon nanotubes, etc., metal-based materials in the form of metal powder or metal fibers containing copper, nickel, aluminum, silver, etc., conductive polymers, such as polyphenylene derivatives, etc., or a mixture thereof.

The first active material layer may further include a positive electrode binder. The positive electrode binder serves to bond particles constituting the positive electrode active material to each other and also attach the positive electrode active material to the first electrode plate 321. Examples of the positive electrode binder include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the positive electrode binder, the aqueous binder may further include a cellulose-based compound capable of imparting viscosity. As the cellulose-based compound, one or more of carboxymethyl cellulose, hydroxypropylmethyl cellulose, methyl cellulose, and an alkali metal salt thereof may be mixed and used. The alkali metal may include Na, K, or Li.

The dry binder may be a polymer material capable of fiberization, for example, polytetrafluoroethylene, polyvinylidene fluoride, polyvinylidene fluoride-hexafluoropropylene copolymer, polyethylene oxide, or a combination thereof.

The first electrode plate 321 may include a first uncoated portion 3211 where the first active material layer 211 is not provided. The first uncoated portion 3211 may protrude a predetermined distance from an end of the electrode assembly 32 along the winding axis.

The second electrode plate 322 may function as a negative electrode of the electrode assembly 32. The second electrode plate 322 may be a foil including a metallic material, such as copper, a copper alloy, nickel, or a nickel alloy. The second electrode plate 322 may face the first electrode plate 321 at a predetermined distance from the first electrode plate 321.

The type, size, shape, etc., of the second electrode plate 322 are not limited as long as the second electrode plate 322 has conductivity and does not cause a chemical change in secondary battery.

At least a part of the second electrode plate 322 may be coated with a second active material layer. Both surfaces of the second electrode plate 322 may be coated with the second active material layer. In other embodiments, only one surface of the second electrode plate 322 may be coated with the second active material layer.

Since the second electrode plate 322 functions as a negative electrode, the second active material layer may include a negative electrode active material. The negative electrode active material may include a material capable of reversible intercalation/deintercalation of lithium ions, a lithium metal, a lithium metal alloy, a material with which lithium is doped or dedoped, or a transition metal oxide.

The material capable of reversibly intercalating/deintercalating lithium ions may be a carbon-based negative electrode active material, which may include, for example, crystalline carbon, amorphous carbon, or a combination thereof. An example of crystalline carbon includes graphite such as amorphous, plate-like, flake-like, spherical, or fiber-like natural graphite or artificial graphite. Examples of amorphous carbon may include soft carbon, hard carbon, mesophase pitch carbide, calcined coke, etc.

As the lithium metal alloy, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material with which lithium is dopped or dedopped, a Si-based negative electrode active material or a Sn-based negative electrode active material may be used. The Si-based negative electrode active material may be silicon, a silicon-carbon composite, SiOₓ (x=1 or 2), a Si-Q alloy, or a combination thereof. In the formula, Si-Q, Q is selected from an alkali metal, an alkaline earth metal, a Group 13 element, a Group 14 element (excluding Si), a Group 15 element, a Group 16 element, a transition metal, a rare earth element, and a combination thereof. The Sn-based negative electrode active material may be Sn, SnO₂, a Sn-based alloy, or a combination thereof.

The silicon-carbon composite may be a composite of silicon and amorphous carbon. According to an embodiment, the silicon-carbon composite may be in the form of silicon particles and amorphous carbon coated on surfaces of the silicon particles. For example, the silicon-carbon composite may include a secondary particle (core) in which primary silicon particles are aggregated and an amorphous carbon coating layer (shell) located on a surface of the secondary particle. The amorphous carbon may be positioned between the primary silicon particles, for example, so that the primary silicon particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer positioned on the surface of the core.

The Si-based negative electrode active material or Sn-based negative electrode active material may be used in combination with a carbon-based negative electrode active material.

The second active material layer may further include a negative electrode conductive material and a negative electrode binder.

The negative electrode conductive material is used to give conductivity to the second active material layer, and any material that is an electrically conductive material that does not cause a chemical change in the battery may be used. Examples of the negative electrode conductive material include carbon-based materials such as natural graphite, artificial graphite, carbon black, acetylene black, Ketjen black, carbon fibers, carbon nanofibers, and carbon nanotubes, metal-based materials in the form of metal powder or metal fibers containing copper, nickel, aluminum, silver, etc., conductive polymers such as polyphenylene derivatives, or a mixture thereof.

The negative electrode binder functions to bond particles constituting the negative electrode active material well and also functions to attach the negative electrode active material to the second electrode plate 322. The negative electrode binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose-based compound capable of providing viscosity. As the cellulose-based compound, one or more of carboxymethyl cellulose, hydroxypropylmethyl cellulose, methyl cellulose, and an alkali metal salt thereof may be mixed and used. The alkali metal may include Na, K, or Li.

The dry binder may be a polymer material capable of fiberization, for example, polytetrafluoroethylene, polyvinylidene fluoride, polyvinylidene fluoride-hexafluoropropylene copolymer, polyethylene oxide, or a combination thereof.

The second electrode plate 322 may include a second uncoated portion 3221 where the second active material layer is not provided. The second uncoated portion 3221 may protrude a predetermined distance from the end of the electrode assembly 32 located at a side opposite to the first uncoated portion 3211 along the winding axis.

A first electrode tab 3212 is electrically connected to the first electrode plate 321, and a second electrode tab 3222 is electrically connected to the second electrode plate 322. One end of the first electrode tab 3212 may be connected to the first uncoated portion 3211 by welding, etc., and the other end may be electrically connected to an upper cap 331. One end of the second electrode tab 3222 may be connected to the second uncoated portion 3221 by welding, etc., and the other end may be welded to the bottom surface of the case 31.

The first electrode tab 3212 may be directly connected to the first electrode plate 321. Alternatively, the first electrode tab 3212 may be indirectly connected to the first electrode plate 321 by way of a first current collecting plate (not illustrated) disposed between the electrode assembly 32 and the cap assembly 33. According to an embodiment, the first electrode tab 3212 may be indirectly connected to the first electrode plate 321 by way of the first current collecting plate (not illustrated) disposed between the electrode assembly 32 and an insulating member 324.

The second electrode tab 3222 may be directly connected to the second electrode plate 322. Alternatively, the second electrode tab 3222 may be indirectly connected to the second electrode plate 322 by way of a second current collecting plate (not illustrated) disposed between the electrode assembly 32 and the case 31. According to an embodiment, the second electrode tab 3222 may be indirectly connected to the second electrode plate 322 by way of the second current collecting plate (not illustrated) disposed between the electrode assembly 32 and a lower insulating member 325.

The separator 323 may be disposed between the first electrode plate 321 and the second electrode plate 322. The separator 323 may prevent a short between the first electrode plate 321 and the second electrode plate 322 while allowing the movement of lithium ions between the first electrode plate 321 and the second electrode plate 322.

As the separator 323, a multilayered membrane of two or more layers of polyethylene, polypropylene, or polyvinylidene fluoride may be used, and a mixed multilayered membrane such as a two-layer separator of polyethylene/polypropylene, a three-layer separator of polyethylene/polypropylene/polyethylene, or a three-layer separator of polypropylene/polyethylene/polypropylene may be used.

The separator 323 may include a porous substrate and a coating layer including an organic material, an inorganic material, or a combination thereof. The coating layer is positioned on one surface or both surfaces of the porous substrate.

The porous substrate may be a polymer film made of a polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, cyclic olefin copolymer, polyphenylene sulfide, polyethylene naphthalate, glass fiber, Teflon, and polytetrafluoroethylene, or a copolymer or mixture of two or more of the above materials.

The organic material may include a polyvinylidene fluoride-based polymer or a (meth)acryl-based polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited to these examples.

The organic material and the inorganic material may be mixed in one coating layer or may be formed by stacking a coating layer containing an organic material and a coating layer including containing an inorganic material.

The separator 323 may be provided as a pair of separators. The pair of separators 323 may face one of both surfaces of the first electrode plate 321 or the second electrode plate 322. The pair of separators 323 may be wound around the winding axis together with the first electrode plate 321 and the second electrode plate 322.

Inside the case 31, the insulating member 324 and the lower insulating member 325 may be disposed on first and second end portions of the electrode assembly 32. The insulating member 324 may be disposed between an upper surface of the electrode assembly 32 (e.g., in a +Z-axis direction) and the cap assembly 33 to insulate between the electrode assembly 32 and the cap assembly 33. The lower insulating member 325 may be disposed between a lower surface of the electrode assembly 32 (e.g., in a -Z-axis direction) and the bottom surface of the case 31 to insulate between the electrode assembly 32 and the case 31.

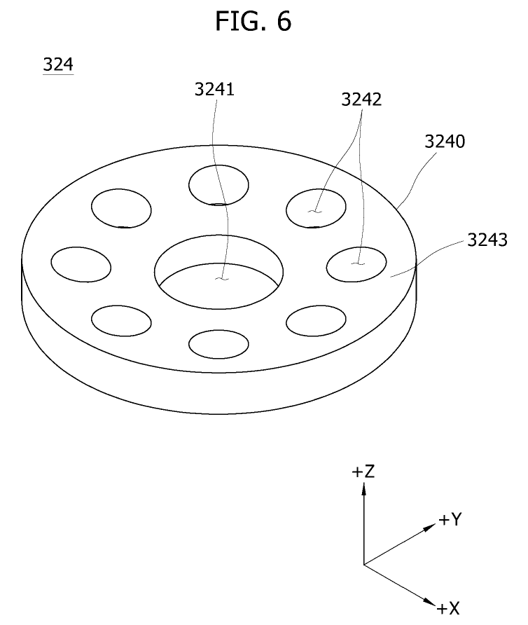

A detailed description of the insulating member 324 will be given below along with the descriptions of FIGS. 6 to 16.

The first electrode tab 3212 and/or the second electrode tab 3222 may be extend through the insulating member 324.

According to an embodiment, the first electrode tab 3212 may extend through a first insulating member hole 3241 formed in the insulating member 324, and the second electrode tab 3222 may protrude downward (e.g., in the -Z-axis direction) from the case 31. As such, the secondary battery may have a bidirectional current collection structure. According to another embodiment, the first electrode tab 3212 and the second electrode tab 3222 may protrude to one side of the electrode assembly 32 (e.g., in the +Z-axis direction or the -Z-axis direction. As such, the secondary battery may have a unidirectional current collection structure. The present disclosure is described based on the bidirectional current collection structure but does not exclude an embodiment for the unidirectional current collection structure and may be applied to the unidirectional current collection structure.

According to another embodiment, the first electrode tab 3212 may be disposed to pass through a second insulating member hole. An example of a second insulating member hole 3242 is shown in FIG. 6.

The cap assembly 33 may be disposed in the case 31. According to an embodiment, the cap assembly 33 may be disposed in the opening of the case 31. More specifically, the cap assembly 33 may seal the opening of the case 31.

The cap assembly 33 may block a current when an internal pressure of the case 31 increases. The cap assembly 33 may be ruptured by the increase in the internal pressure of the case 31 so that an inside and outside of the case 31 are in fluid communication with each other. As the inside and the outside of the case 31 are in fluid communication with each other, gas may be discharged from the secondary battery 3 and the internal pressure of the case 31 decreases. Thus, there is a reduced risk of explosion of the secondary battery 3.

The cap assembly 33 may be coupled to the case 31 to seal the opening of the case 31. Specifically, the case 31 may have a beading part 311 that is concave inward, and a part of the case 31 may be bent inward to form a crimping part 312 on an upper portion of the cap assembly 33 so that the cap assembly 33 may be coupled to the case 31. The beading part 311 and the crimping part 312 may tightly fix and support the cap assembly 33 to the case 31, thereby preventing the cap assembly 33 from being detached and also preventing the electrolyte from leaking to outside of the secondary battery.

The cap assembly 33 may include a vent plate 332. The cap assembly 33 may include the upper cap 331, and the cap assembly 33 may include a lower cap 333. The cap assembly 33 may further include a spacing insulating part 334. The cap assembly 33 may also include a gasket 335. In sum, the cap assembly 33 may include the upper cap 331, the vent plate 332, the lower cap 333, the spacing insulating part 334, and the gasket 335.

The upper cap 331 may be electrically connected to the electrode assembly 32. According to an embodiment, the upper cap up 331 may be electrically connected to the first electrode plate 321 to function as a positive electrode. The upper cap up 331 may have a height (e.g., in the Z-axis direction) that is the same as or similar to that of the crimping part 312.

According to one embodiment, the upper cap 331 protrudes outward from the case 31. A part of the upper cap 331 may be disposed at a location higher than the height of the case 31 (e.g., in the Z-axis direction). According to another embodiment, the upper cap 331 may be disposed at a lower height (e.g., in the Z-axis direction) than the crimping part 312.

The cap assembly 33 may include an upper cap hole 3311 extending through the upper cap 331. A substance such as gas or the like generated inside the case 31 may be discharged to outside of the case 31 through the upper cap hole 3311.

The vent plate 332 may be disposed between the upper cap 331 and the electrode assembly 32. According to one embodiment, the vent plate 332 may be disposed under the upper cap 331 (e.g., in the Z-axis direction). The vent plate 332 may be electrically connected to the upper cap 331. A part of the upper cap 331 may contact the vent plate 332. A part of the upper cap 331 may be surrounded by the vent plate 332. Both surfaces of an end portion of the upper cap 331 may be surrounded by the vent plate 332 to contact the vent plate 332. Accordingly, the upper cap 331 may be fixed to the vent plate 332, and the upper cap up 331 may be electrically connected to the electrode assembly 32.

The vent plate 332 may move when the internal pressure of the case 31 increases. More specifically, when the internal pressure of the case 31 increases, the vent plate 332 may move toward the opening of the case 31 (e.g., in the +Z-axis direction) and toward the upper cap 331. As the vent plate 332 moves toward the upper cap 331, an internal volume of the case 31 may increase, and the internal pressure of the case 31 may decrease.

As the vent plate 332 moves it may be electrically disconnected from the lower cap 333 and/or the electrode assembly 32. In this way, since the vent plate 332 moves due to the increase in the internal pressure of the case 31 and the vent plate 332 and the electrode assembly 32 are electrically disconnected, it is possible to prevent a sudden explosion of the secondary battery 3.

The vent plate 332 may include a vent plate notch 3321. The vent plate notch 3321 may be provided as a concavely formed groove. But the shape of the vent plate notch 3321 is not limited, and the number of vent plate notches 3321 may be one or more. As the vent plate notch 3321 is formed in the vent plate 332, the vent plate notch 3321 may rupture earlier than other portions of the vent plate 332 due to an external force. As the vent plate notch 3321 is ruptured earlier than the other portions of the vent plate 332, and the inside and the outside of the case 31 may be in fluid communication with each other. The internal pressure of the secondary battery 3 can be reduced through the ruptured portion of the vent plate notch 3321 and the upper cap hole 3311, and an explosion of the secondary battery 3 can be prevented.

The vent plate 332 may include a vent plate contact portion 3322. The vent plate contact portion 3322 may be electrically connected to the lower cap 333. In particular, the vent plate contact portion 3322 may protrude downward (e.g., in the -Z-axis direction) and be electrically connected to the lower cap 333. In another embodiment, the vent plate contact portion 3322 may be electrically connected to the lower cap 333 without protruding downward from the vent plate 332.

The vent plate contact portion 3322 may extend through a hole in the lower cap 333. More specifically, the vent plate contact portion 3322 may extend through a first lower cap hole 3331 formed through the lower cap 333. The vent plate contact portion 3322 may be electrically connected to the first electrode tab 3212 through the first lower cap hole 3331. Accordingly, the first lower cap hole 3331 and the first electrode tab 3212 can be electrically connected.

Because the cap assembly 33 may include the vent plate 332, when the internal pressure of the case 31 exceeds a predetermined pressure, gas can be discharged to outside of the secondary battery 3. Thus, an explosion of the secondary battery 3 can be prevented.

The lower cap 333 may be disposed between the vent plate 332 and the electrode assembly 32. The lower cap 333 may be disposed under the vent plate 332 (e.g., in the -Z-axis direction). And the lower cap 333 may be electrically connected to the vent plate 332 and/or the electrode assembly 32.

The cap assembly 33 may include the first lower cap hole 3331 extending through the lower cap 333. The first lower cap hole 3331 may allow both surfaces of the lower cap 333 (e.g., in the -Z-axis direction) to communicate with each other. The first lower cap hole 3331 may be disposed at a center of the lower cap 333.

The cap assembly 33 may include a second lower cap hole 3332 extending through the lower cap 333. As the second lower cap hole 3332 extends through both surfaces of the cap down 333, gas generated from the electrode assembly 32 inside the case 31 may pass through the second lower cap hole 3332. When the internal pressure of the case 31 increases, the increased pressure may act on the vent plate 332. The second lower cap hole 3332 may be disposed at an edge of the lower cap 333.

The second lower cap hole 3332 may be provided as a plurality of second lower cap holes. The shape of the second lower cap down hole 3332 may be provided in the form of a long hole. But the shape of the second lower cap hole 3332 is not limited and may be provided in various forms.

The spacing insulating part 334 may be disposed between the vent plate 332 and the lower cap 333. The spacing insulating part 334 may not be electrically conducted due to an insulating material included therein. Because the spacing insulating part 334 is disposed between the vent plate 332 and the cap down 333, the vent plate 332 and the lower cap 333 are insulated from each other by the spacing insulating part 334. Accordingly, the vent plate 332 and the lower cap 333 may be electrically connected by only direct contact between the vent plate 332 and the cap down 333.

The spacing insulating part 334 may be formed from polypropylene (PP), polybutylene terephthalate (PBT), polyethylene (PE), a fluoropolymer, etc. The spacing insulating part 334 may be manufactured by injection molding. Accordingly, the spacing insulating part 334 may be integrally formed.

The vent plate 332 may be disposed above the spacing insulating part 334 (e.g., in the +Z-axis direction), and the lower cap 333 may be disposed under the spacing insulating part 334 (e.g., in the -Z-axis direction). As the spacing insulating part 334 is disposed between the vent plate 332 and the lower cap 333, the spacing insulating part 334 may support the vent plate 332. Since the spacing insulating part 334 supports the vent plate 332, it is possible to prevent the deformation of the vent plate 332.

When the internal pressure of the case 31 increases, the vent plate 332 moves upward (e.g., in the +Z-axis direction) so that the vent plate 332 and the electrode assembly 32 are electrically disconnected. And as the vent plate 332 is supported by the spacing insulating part 334, the vent plate 332 may move toward the upper cap up 331. Thus, when the internal pressure of the case 31 increases, the vent plate 332 may move toward the upper cap 331.

An adhesive may be disposed on an outer side of the spacing insulating part 334. The adhesive may be fixedly attach the spacing insulating part 334 to the vent plate 332 and/or the lower cap 333. In this way, as the spacing insulating part 334 is fixedly attached to the vent plate 332 and/or the lower cap 333, deformation of the vent plate 332 may be reduced.

The gasket 335 may be disposed on a side of the case 31 in a substantially ring shape. The gasket 335 may be disposed on an inner side of the case 31. The gasket 335 may fix the cap assembly 33 according to the shape of the beading part 311 and/or the crimping part 312. In one embodiment, the gasket 335 may fix the upper cap 331, the vent plate 332, and/or the lower cap 333 of the cap assembly 33. The gasket 335 may insulate the cap assembly 33 from the case 31. In particular, the gasket 335 may insulate the upper cap 331, the vent plate 332, and the lower cap 333 from the case 31.

The gasket 335 may be disposed on an inner surface of the crimping part 312 and surround the vent plate 332. As the gasket 335 surrounds the vent plate 332, the vent plate 332 may be insulated from the case 31. The vent plate 332 can be deformed by a force applied to a lower side of the secondary battery 3 from the vent plate 332.

The gasket 335 may be disposed on the inner surface of the beading part 311 to be in contact with the lower cap 333. As the gasket 335 comes into contact with the cap down 333, the lower cap 333 may be insulated from the case 31. The lower cap 333 may be supported by the gasket 335. As the gasket 335 supports the lower cap 333, the lower cap 333 moves into contact with the spacing insulating part 334, and the spacing insulating part 334 disposed between the vent plate 332 and the lower cap 333 supports the vent plate 332, the deformation of the vent plate 332 can be reduced by the vent plate 332 and the spacing insulating part 334.

According to another embodiment, the lower cap 333 may be spaced apart from the case 31 without being in contact with the gasket 335 so that the lower cap 333 and the case 31 may be insulated from each other.

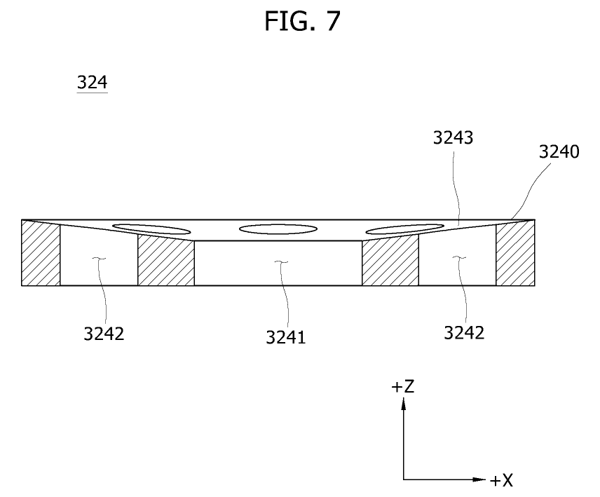

FIG. 6 is a perspective view illustrating an insulating member according to a first embodiment of the present disclosure, and FIG. 7 is a cross-sectional view illustrating the insulating member according to the first embodiment of the present disclosure.

The insulating member 324 may be disposed inside the case 31. According to one embodiment, the insulating member 324 may be disposed between the electrode assembly 32 and the cap assembly 33. as such, the insulating member 324 may allow the electrode assembly 32 to be spaced apart from the cap assembly 33. The insulating member 324 may be formed from polypropylene (PP)or various other materials. According to one embodiment, the insulating member 324 may be provided as a tape. In still further embodiments, the insulating member 324 may include polyimide (PI) or polyethylene.

The insulating member 324 may include an insulating member body 3240, the first insulating member hole 3241, and an inclined surface 3243. The shape of the insulating member body 3240 may be provided in the form of substantially a circular plate. The insulating member body 3240 may be disposed inside the case 31 and disposed between the electrode assembly 32 and the cap assembly 33. Accordingly, the insulating member body 3240 may make the electrode assembly 32 be spaced apart from the cap assembly 33.

The first insulating member hole 3241 may pass through the insulating member body 3240. The first insulating member hole 3241 may extend in a direction parallel to a thickness direction (e.g., the Z-axis direction) of the insulating member body 3240.

The first insulating member hole 3241 may be disposed at a center of the insulating member body 3240 in a direction perpendicular to the thickness direction of the insulating member body 3240. In particular, the first insulating member hole 3241 may be disposed in a central portion of the insulating member body 3240. A cross-sectional area of the first insulating member hole 3241 perpendicular to a direction parallel to the first direction (e.g., the Z-axis direction) may be provided as 5% to 30% of an area of the insulating member 324. The shape of the first insulating member hole 3241 may be a circle. But the shape of the first insulating member hole 3241 is not limited to a circle and may be various other shapes, such as a polygon, a closed curve, etc.

The inclined surface 3243 may be disposed on an upper side of the insulating member body 3240 (e.g., the uppermost surface in the +Z-axis direction). The inclined surface 3243 may extend in a direction intersecting a direction perpendicular to the thickness direction (e.g., the Z-axis direction) of the insulating member body 3240. According to one embodiment, the inclined surface 3243 may extend in a direction intersecting the direction perpendicular to the thickness direction of the insulating member body 3240.

The inclined surface 3243 may be sloped such that a height (i.e., thickness in the Z-axis direction) of the insulating member body 3240 increases or decreases toward a center of the insulating member body 3240. Accordingly, the height of the insulating member 324 (e.g., in the Z-axis direction) may vary according to a location of the insulating member 324. In one embodiment, a length of the insulating member 324 in the first direction (e.g., the Z-axis direction) may be the shortest at a central portion of the insulating member 324 and the longest at an edge of the insulating member 324. The shortest length of the insulating member 324 in the first direction may be 60% to 90% of the longest length of the insulating member 324 in the first direction.

As the inclined surface 3243 is disposed on the insulating member body 3240, an electrolyte injected into the secondary battery 3 may flow along the inclined surface 3243 of the insulating member body 3240. In particular, the electrolyte may flow along the inclined surface 3243 toward the first insulating member hole 3241. Thus, as the inclined surface 3243 is formed on the insulating member body 3240, a flow rate of the electrolyte may be increased and the time required for electrolyte injection may be decreased, especially as compared to a configuration where the surface 3243 is not inclined.

One or more second insulating member holes 3242 may be formed in the insulating member 324. In an embodiment, when the insulating member 324 is viewed inthe first direction (e.g., the Z-axis direction), the sum of the area of the first insulating member hole 3241 and the areas of the second insulating member holes 3242 may be 10% to 50% of the area of the insulating member 324.

The second insulating member holes 3242 may pass through the insulating member body 3240. The second insulating member holes 3242 may extend in the direction parallel to the thickness direction (e.g., the Z-axis direction) of the insulating member body 3240. According to another embodiment, the second insulating member holes 3242 may extend in a direction intersecting the thickness direction of the insulating member body 3240. The second insulating member holes 3342 may extend parallel to each other or extend not parallel to each other.

The second insulating member holes 3242 may be disposed at an edge of the insulating member body 3240 in the direction perpendicular to the thickness direction of the insulating member body 3240. The plurality of second insulating member holes 3242 may surrounded the first insulating member hole 3241.

As the first insulating member hole 3241 and the second insulating member holes 3242 extend through the insulating member body 3240, the electrolyte can quickly flow into the case 31. Accordingly, the time required to inject an electrolyte into the secondary battery 3 can be reduced.

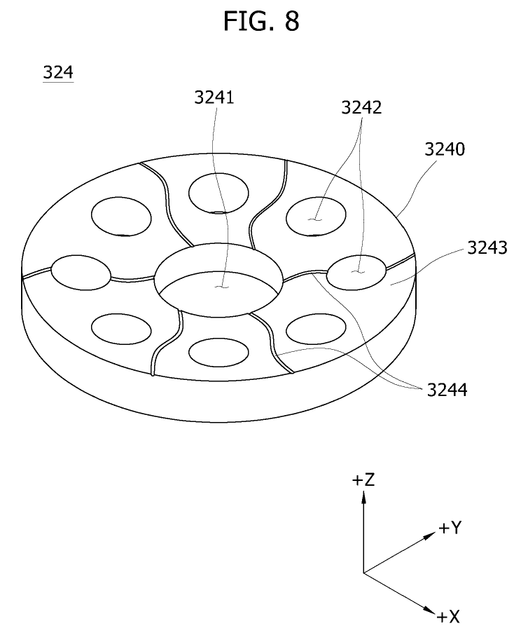

FIG. 8 is a perspective view of an insulating member according to a second embodiment of the present disclosure.

The insulating member 324 may further include an insulating member groove 3244. The insulating member groove 3244 may be provided as a concave groove in the insulating member body 3240. According to one embodiment, the insulating member groove 3244 may be disposed in the inclined surface 3243. The electrolyte injected into the secondary battery 3 may flow to the insulating member groove 3244 along the inclined surface 3243 and then flow inthe insulating member groove 3244.

A depth of the insulating member groove 3244 (e.g., in the Z-axis direction) may be provided as 5% to 40% of a thickness of the insulating member body 3240 (e.g., thickness of the insulating member body 3240 in the Z-axis direction). The thickness of the insulating member body 3240 may correspond to a length of the first insulating member hole 3241 (e.g., in the Z-axis direction).

The cross-sectional shape of the insulating member groove 3244 may be triangle. But the cross-sectional shape of the insulating member groove 3244 is not limited to a triangle, and may be various other shapes, such as a fan, semicircle, triangle, quadrangle, curve, etc.

The insulating member groove 3244 may include a straight portion and/or a curved portion. According to an embodiment, the insulating member groove 3244 may be provided as a plurality of insulating member grooves. The insulating member groove 3244 may be connected to the first insulating member hole 3241. Accordingly, the electrolyte flowing along the insulating member groove 3244 may flow to the first insulating member hole 3241. In addition, or in alternative, the insulating member groove 3244 may be connected to the second insulating member hole 3242. As the insulating member groove 3244 is connected to the second insulating member hole 3242, the electrolyte flowing along the insulating member groove 3244 may flow to the second insulating member hole 3242 and into the case 31 before flowing to the first insulating member hole 3241. In some embodiments, the insulating member groove 3244 may connect the first insulating member hole 3241 to the second insulating member hole 3242.

As the insulating member groove 3244 is formed in the insulating member body 3240, the electrolyte can quickly flow into the secondary battery 3, thereby shortening the time required for electrolyte injection.

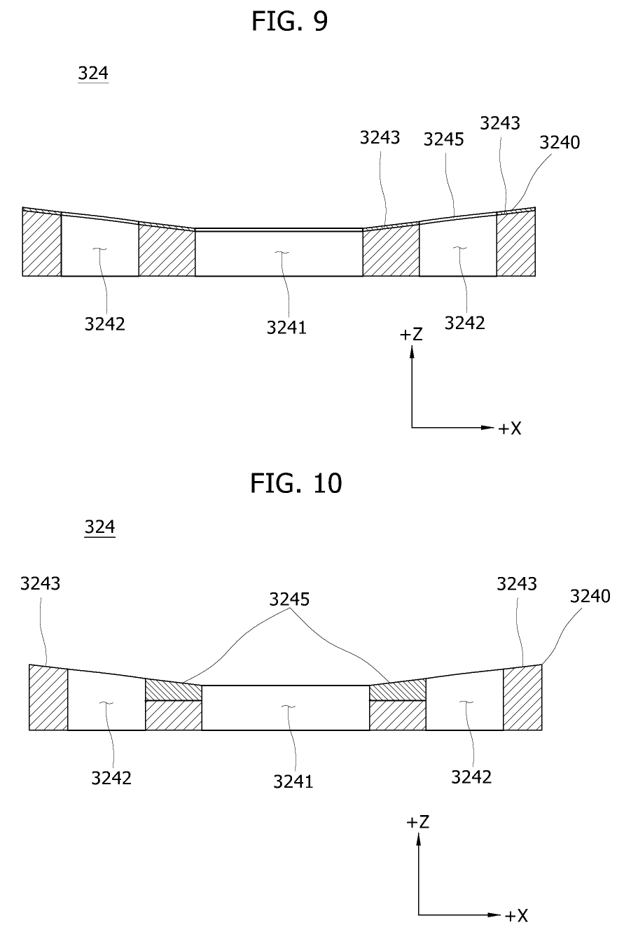

FIG. 9 is a cross-sectional view of an insulating member according to a third embodiment of the present disclosure.

The insulating member 324 may further include an insulating body 3245. The insulating body 3245 may be disposed on the upper side of the insulating member body 3240 (e.g., in the +Z-axis direction). In particular, the insulating body 3245 may be disposed on the inclined surface 3243 of the insulating member body 3240. As the insulating body 3245 is disposed on the upper side of the insulating member body 3240, the first electrode tab 3212 may be fixed to the insulating body 3245.

The insulating body 3245 may be formed from oriented polystyrene (OPS), polyurethane, an acrylic resin, polypropylene, or polyimide. But the materials the insulating body 3245 is formed from are limited to these examples and may include various other materials.

In a process of making the secondary battery, the electrolyte may contact the insulating body 3245 to partially dissolve the insulating body. As the insulating body 3245 is partially dissolved by the electrolyte, adhesion may be generated between the insulating body 3245 and the insulating member body 3240. Thus, the insulating body 3245 may be fixed to the insulating member body 3240.

The insulating body 3245 may be disposed on the entirety of the inclined surface 3243. As the insulating body 3245 is disposed on the inclined surface 3243 in this way, the first electrode tab 3212 may be fixed to the insulating body 3245. With the first electrode tab 3212 fixed to the insulating body 3245, even if there is an impact to the secondary battery 3, the first electrode tab 3212 may be fixed to the insulating body 3245, which thereby prevents the occurrence of a short. That is, it is possible to prevent a short from occurring inside the secondary battery 3, and the stability of the secondary battery 3 is thereby improved.

FIG. 10 is a cross-sectional view of an insulating member according to a fourth embodiment of the present disclosure.

The insulating body 3245 may be disposed on a part of the inclined surface 3243. In particular, the insulating body 3245 may be disposed on a central portion of the inclined surface 3243. Since the insulating body 3245 is disposed on a part of the inclined surface 3243, it is possible to reduce the consumption (usage amount) of the insulating body 3245 and reduce cost.

A hole may be formed in the insulating body 3245. The hole may be formed in the insulating body 3245 at a position corresponding to a location of the first insulating member hole 3241 formed in the insulating member body 3240.

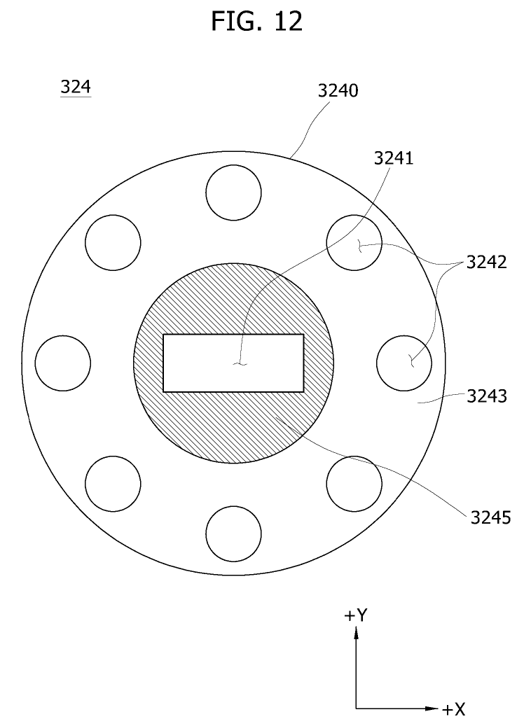

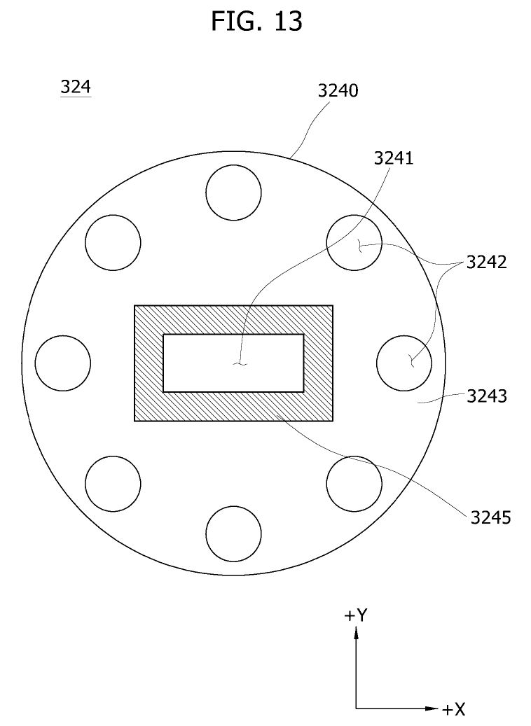

The shape of the insulating body 3245 may vary. According to one embodiment, the shape of the insulating body 3245 may be substantially circular (see FIG. 12). According to another embodiment, the shape of the insulating body 3245 may be substantially quadrangular (see FIG. 13).

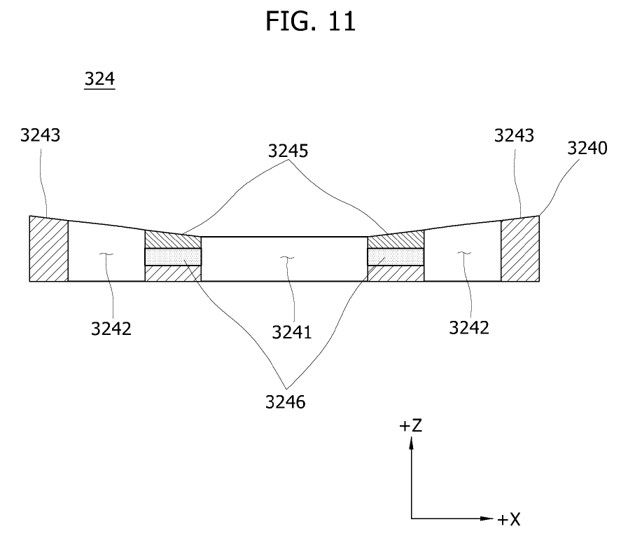

FIG. 11 is a plan view of an insulating member according to a fifth embodiment of the present disclosure.

The insulating member 324 may further include an adhesive 3246.

The adhesive 3246 may be disposed between the insulating member body 3240 and the insulating body 3245 and be disposed on the upper side of the insulating member body 3240 (e.g., in the +Z-axis direction). The adhesive 3246 may be thereby fix the insulating body 3245 to the insulating member body 3240. Because the adhesive 3246 fixes the insulating body 3245 to the insulating member body 3240, even when there is an impact on the secondary battery 3, the insulating body 3245 may not detatch from being detached from the insulating member body 3240. Accordingly, the first electrode tab 3212 may be fixed to the insulating body 3245.

The sum of a length (e.g., a thickness) of the insulating body 3245 and a length (e.g., a thickness) of the adhesive 3246 in the first direction (e.g., in the Z-axis direction) may be 70% or less of the maximum length of the insulating member 324 in the first direction. According to another embodiment, the sum of the length of the insulating body 3245 and the length of the adhesive 3246 in the first direction may be provided as 50% or less of the maximum length of the insulating member 324 in the first direction. Here, the maximum length of the insulating member 324 in the first direction may refer to the thickness of the edge of the insulating member body 3240 (e.g., in the Z-axis direction). Since the length of the insulating body 3245 and the length of the adhesive 3246 in the first direction are provided as a predetermined ratio or less of the maximum length of the insulating member 324, durability of the insulating member 324 is ensured.

FIG. 12 is a plan view of an insulating member according to a sixth embodiment of the present disclosure, and FIG. 13 is a plan view of an insulating member according to a seventh embodiment of the present disclosure.

The shape of the insulating body 3245 disposed on the insulating member 324 is circular (see FIG. 12) or quadrangular (see FIG. 13). But the shape of the insulating body 3245 is not limited to a circle or a quadrangle, and the insulating body 3245 may be provided in various shapes, such as a polygon, ellipse, closed curve, etc.

The shape of the first insulating member hole 3241 extending through the insulating member body 3240 may be quadrangular. The first electrode tab 3212 may be bent to overlap the first insulating member hole 3241 in a longitudinal direction of the first insulating member hole 3241.

A diameter of the insulating body 3245 disposed in the insulating member body 3240 may be 70% or less of a diameter of the insulating member 324 (see FIG. 12). According to another embodiment, the diameter of the insulating body 3245 may be 50% or less of the diameter of the insulating member 324.

An area of a flat surface (e.g., an X-Y plane) of the insulating body 3245 disposed on the insulating member body 3240 may be 70% or less of an area of a flat surface (e.g., the X-Y plane) of the insulating member 324 (see FIG. 13). According to another embodiment, the area of the insulating body 3245 may be 50% or less of the area of the insulating member 324.

By arranging the insulating body 3245 at a contact portion of the first electrode tab 3212, it is possible to reduce the consumption (usage amount) of the insulating body 3245 and thereby reduce cost.

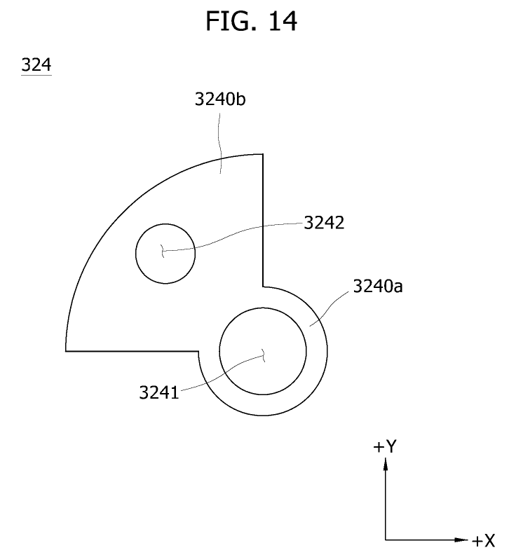

FIGS. 14 to 16 are plan views of an insulating member according to an eighth embodiment of the present disclosure.

The insulating member body 3240 may include an insulating member central portion 3240a and an insulating member body piece 3240b. A first insulating member hole 3241 may be formed in the insulating member central portion 3240a, and the second insulating member hole 3242 may be formed in the insulating member body piece 3240b.

According to an embodiment, the insulating member body 3240 may include a plurality of insulating member central portions 3240a and a plurality of insulating member body pieces 3240b. Four insulating member body pieces 3240b are illustrated in the embodiment depicted in FIGS. 14 to 16, but the number of insulating member body pieces 3240b is not limited to four.

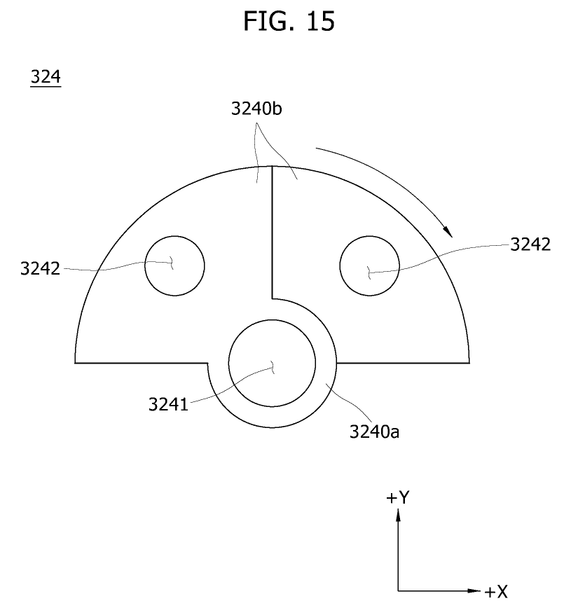

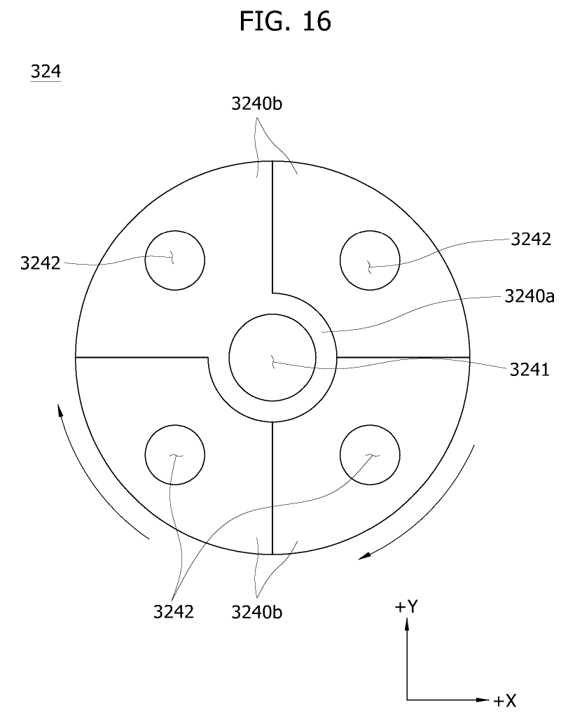

The plurality of insulating member central portions 3240a and the plurality of insulating member body pieces 3240b may be be stacked in the first direction (e.g., in the Z-axis direction). In particular, the plurality of insulating member central portions 3240a may be stacked and rotated. The insulating member body pieces 3240b connected to the insulating member central portions 3240a may be provided at positions fully about a center (see FIGS. 15 and 16). When the insulating member central portions 3240a are rotates to form a full circle, the insulating member central portion 3240a may function as the insulating member 324.

According to another embodiment, the plurality of insulating member body pieces 3240b may be spaced apart from each other and provided in a fan shape. And the plurality of insulating member body pieces 3240b provided in the fan shape may function as the insulating member 324. When the electrolyte is injected into the secondary battery 3 in a state in which the insulating member body pieces 3240b are overlapped and stacked, it is possible to reduce the amount of flow being blocked by the insulating member 324, thereby reducing the time required for electrolyte injection. In addition, it is possible to minimize the amount of electrolyte remaining on the insulating member 324. Accordingly, it is possible to reduce the amount of electrolyte that needs to be provided to the secondary battery. After the electrolyte injection into the secondary battery 3 is completed, the insulating member central portion 3240a may be rotated to form a full circle, and the insulating member central portion 3240a may function as the insulating member 324.

According to embodiments of the present disclosure, it is possible to minimize the time required for electrolyte injection.

In addition, according to embodiments of the present disclosure, it is possible to prevent a short in a secondary battery, thereby improving stability of the secondary battery.

Furthermore, according to the present disclosure, it is possible to reduce the amount of electrolyte that needs to be provided to a secondary battery.

However, the effects obtainable through the present disclosure are not limited to the above effects, and other technical effects that are not mentioned will be clearly understood by those skilled in the art from the description.

While the present disclosure has been described with reference to embodiments shown in the drawings, these embodiments are merely illustrative and it should be understood that various modifications and equivalent other embodiments can be derived by those skilled in the art on the basis of the embodiments.

What is claimed is:

1. A secondary battery comprising:
a case having an opening formed therein, the case extending in a first direction;
an electrode assembly accommodated in the case;
a cap assembly sealing the opening in the case; and
an insulating member including an insulating member body disposed between the electrode assembly and the cap assembly, the insulating member including an inclined surface disposed on an upper side of the insulating member body and extending in a direction intersecting a second direction perpendicular to the first direction, and an insulating member hole is formed in the insulating member body, with the insulating member hole extending through the insulating member body.

2. The secondary battery as claimed in claim 1, wherein a length of the insulating member in the first direction decreases toward a center of the insulating member to thereby form an inclination of the inclined surface.

3. The secondary battery as claimed in claim 1, wherein the insulating member hole is disposed in a central portion of the insulating member body in the second direction.

4. The secondary battery as claimed in claim 1, wherein the insulating member hole is a first insulating member hole, and
wherein the insulating member includes a second insulating member hole disposed at an edge of the insulating member body and extending through the insulating member body.

5. The secondary battery as claimed in claim 4, wherein a sum of a cross-sectional area of the first insulating member hole and a cross-sectional area of the second insulating member hole ranges from 10% to 50% of a cross-sectional area of the insulating member.

6. The secondary battery as claimed in claim 1, wherein the insulating member includes an insulating member groove formed as a concave groove in the inclined surface.

7. The secondary battery as claimed in claim 6, wherein the insulating member groove is connected to the insulating member hole.

8. The secondary battery as claimed in claim 6, wherein the insulating member hole is a first insulating member hole, and
wherein a second insulating member hole is formed at an edge of the insulating member body and extends through the insulating member body; and
wherein an insulating member groove formed as a concave groove in the inclined surface and connected to the second insulating member hole.

9. The secondary battery as claimed in claim 6, wherein a cross-sectional shape of the insulating member groove is triangular, and
wherein a depth of the insulating member groove is 5% to 40% of a length of the insulating member in the first direction.

10. The secondary battery as claimed in claim 1, wherein the electrode assembly includes an electrode tab electrically connected to the cap assembly and extending through the insulating member.

11. The secondary battery as claimed in claim 1, wherein the insulating member body includes a plurality of insulating member body pieces that overlap each other.

12. The secondary battery as claimed in claim 11, wherein the plurality of insulating member body pieces are rotatable about the insulating member hole.

13. The secondary battery as claimed in claim 1, wherein the insulating member includes an insulating body disposed on the inclined surface.

14. The secondary battery as claimed in claim 13, wherein the insulating member includes an adhesive disposed between the inclined surface and the insulating body to fix the insulating body to the inclined surface.

15. The secondary battery as claimed in claim 14, wherein lengths of the insulating body and the adhesive in the first direction are 70% or less of a maximum length of the insulating member in the first direction.

16. The secondary battery as claimed in claim 13, wherein an area of the insulating body is 50% or less of an area of the inclined surface.

17. A battery pack comprising:
a housing; and
a plurality of secondary batteries disposed in the housing,
wherein each of the secondary batteries includes:
a case having an opening formed therein, the case extending in a first direction;
an electrode assembly accommodated in the case;
a cap assembly sealing the opening in the case; and
an insulating member including an insulating member body disposed between the electrode assembly and the cap assembly, the insulating member including an inclined surface disposed on an upper side of the insulating member body and extending in a direction intersecting a second direction perpendicular to the first direction, and an insulating member hole is formed in the insulating body, with the insulating member hole extending through the insulating member body.

18. The battery pack as claimed in claim 17, wherein a length of the insulating member in the first direction decreases toward a center of the insulating member to thereby form an inclination of the inclined surface.

19. The battery pack as claimed in claim 17, wherein the insulating member hole is disposed in a central portion of the insulating member body in the second direction.

20. The battery pack as claimed in claim 17, wherein the insulating member hole is a first insulating member hole, and
wherein the insulating member includes a second insulating member hole disposed at an edge of the insulating member body and extending through the insulating member body.
